(19) United States
(12) Patent Application Publication
(10) Pub. No.: US 2005/0149349 A1
(43) Pub. Date: Jul. 7, 2005

(54) Method of processing clinical materials for medical research

(76) Inventor: William D. Travis, Rockville, MD (US)

Correspondence Address: BANNER & WITCOFF, 1001 G STREET N W, SUITE 1100, WASHINGTON, DC, 20001, US

(21) Appl. No.: 10/745,652

(22) Filed: Dec. 29, 2003

(51) Int. Cl. G06F 17/60

(52) U.S. Cl. 705/2

(57) ABSTRACT

A method processing clinical material for medical research includes receiving samples and accompanying records and providing them with a removable label that is placed over information originally provided on the sample, records or other material. The removable label includes an identifying patient code, but arbitrary to the actual identity of the patient. The patient code is matched with the actual confidential patient information in a generally non-accessible location. The label includes an adhesive whereby the label can be removed without damaging the original information. In this way, the labels can be removed if the materials need to be sent back to the treating physician. Additionally, the use of removable labels enables the individual(s) designated with labeling the material when it comes into the research facility to double check the correctness of the new labeling if necessary. For patient data stored in an electronic or digital format, the researcher can be given an electronic or digital copy of the data labeled with the research patient code identifier but with the confidential patient information obscured electronically. Confidentiality for the researchers can be maintained by having the researches verify, by a written statement or otherwise, that the applied labels have not been removed while the materials were in their possession.

### FIELD OF THE INVENTION

The present invention pertains to a method of processing clinical materials to facilitate research of the materials while protecting the privacy of the patient.

### BACKGROUND OF THE INVENTION

For effective medical research, it is essential for researchers to study samples from actual patients suffering with a particular disease or disorder related to the study. Accordingly, physicians involved in patient treatment provide tissue samples from their patients to the researchers. The samples may, for example, be on slides (histologic, cytologic, hematologic or other laboratory preparation), paraffin blocks, an electronic or digital file (i.e. radiologic or imaging study, sometimes stored on a device such as a compact or hard disk) or another type of sample storage container. For research use, the sample may have also been treated, such as with an acid fast stain or keratin stain. These samples usually have labels that may include one or more of a patient identifying number used by the treating physician, an identifying number used by a laboratory or department that treated the sample, a brief description of the sample, the patient's name and/or other information. The samples are often transferred to the research facility with copies of medical records of the patient including treatments, symptoms, diagnoses, imaging studies, test results, etc. The research facility also typically adds identifying numbers and other information to the samples and records. The medical records will also usually include identifying numbers used by the treating physician along with the patient's name and possibly other patient identifying information.

Interest in maintaining a patient's privacy has been growing in recent years. In the U.S., the Health Insurance Portability and Accountability Act (HIPAA) requires that patient information be maintained confidential from all but the treating physician without previous consent from the patient to safeguard the patient's privacy. Many samples, however, were collected prior to the enactment of HIPAA, are sent for research studies without such consent even if given, or they are received by a research facility outside of the U.S. In these cases, protection of the patient's privacy and compliance with HIPAA has been achieved by removing the identifying labels from the samples or records, or obliterating the information so that none of the patient identifying information can be read. This action though reduces the ability of the researchers to keep track of which samples and records are for which patients—thus risking compromise of the research. Others seek to selectively obliterate only the patients' names and other patient identifying information. This process, however, takes time to review the material and is susceptible to obliterating too much or too little of the information. Moreover, the samples and other materials sometimes need to be returned to the treating physician for clinical use. Loss of the patient information is unacceptable in these instances. As a result, some research facilities operate without concern for patients' privacy and in non-compliance with HIPAA in order to advance the research being conducted.

### SUMMARY OF THE INVENTION

An objective of the present invention is to advance medical research and to concurrently protect a patient's privacy. Another objective of the present invention is to facilitate research in compliance with HIPAA and avoid the shortcomings of past efforts.

In accordance with the present invention, the samples and accompanying records are provided with a label that is placed over the information originally provided on the sample, records or other material. In this way, any patient identifying information originally on the sample or material is occluded. The label includes a patient research code identifier unique to the patient, but arbitrary to the actual identity of the patient, and lacks any patient identifying information. For patient data that is stored in an electronic or digital format such as images, the digital of electronic files provided to the researcher would have an electronic label that matched the patient research code identifier and the confidential patient information would be obscured.

The patient code is matched with the actual confidential patient information, which is recorded and stored in a location generally non-accessible to the primary researcher. The label includes an adhesive whereby the label can be removed without damaging the original information provided on the sample or other material. In this way, the labels can be removed if the materials need to be sent back to the treating physician. Additionally, the use of removable labels enables the individual(s) designated with labeling the material when it comes into the research facility to double check the correctness of the new labeling if necessary. Confidentiality for the researchers can be maintained by having the researchers verify, by a written statement or otherwise, that the applied labels have not been removed while the materials were in their possession.

In a preferred embodiment, the applied label for the sample includes a description of the nature of the sample, the nature of its treatment (e.g., the stain), and other information useful to the researcher. The labels are preferably made by one or more individuals (research administrators) who are not involved in the actual research or evaluations of the samples or data.

The confidential patient information is preferably entered into a database in a computer system that matches the information with the patient code. The confidential patient information is then made available only to the one or more individuals not involved in research. However, the relevant information about the patient needed for the research project can be entered into a database, matched with the patient code, and made available to the researcher. The researcher can then access, study and assess the information as needed for the research without having access to the confidential patient information. In this way, confidential information can be maintained without jeopardizing the work of the researcher or the privacy of the patient.

Also, the applied labels preferably streamline and simplify the information on the labels to make it easier for the researcher to read and ascertain the information needed for the study. The miscellaneous information and numbers from the treating physician(s) and laboratories that have previously handled the samples and records, that are irrelevant to the current research, are hidden by the new labels. This not only makes it easier for the research to read the new labels, but also avoids mistakes in noting the wrong information on the crowded or busy labels of the past.

### BRIEF DESCRIPTION OF THE DRAWINGS

FIG. 1 is a top plan view of a slide with a label received for study at the research facility.

FIG. 2 is a partial perspective view of a patient folder containing a medical record from a treating physician.

FIG. 3 is a top plan view of a slide with a new label in accordance with the present invention.

FIG. 4 is a partial perspective view of a patient folder with a new label in accordance with the present invention.

### DETAILED DESCRIPTION OF THE PREFERRED EMBODIMENTS

Tissue samples from patients suffering diseases or other conditions under study are commonly transferred to research facilities to aid the study of the disease or condition and further the development of treatment or a cure. This practice of obtaining specimens from the treating physician is essential for research to continue. The researchers themselves may not be the primary physician treating the patients and, thus, may have no other source of samples to study.

Specimens or tissue samples 1 are generally transferred to medical research facilities on a slide 3 or other medium (FIG. 1). It is common for the tissue sample to be treated by a laboratory before being sent to the research facility. For example, the sample 1 may have been treated with an acid fast stain or a keratin stain to enhance the study of the tissue. Slide 3 will usually be provided with one or more entries of information 11 on at least one side 3a of thereof. The entries 11 are commonly provided on a label 5. As one example, label 5 is affixed to end 3a of slide 3 so as to avoid interference with specimen 1. Label 5 includes a first entry of information 11a with an identifying code of letters and/or numbers that generally corresponds to the file (and/or identity) of the patient for the primary treating physician, a second entry of information 11b that identifies the patient by name, a third entry of information 11c that identifies the primary treating physician, a fourth entry of information 11d that identifies the tissue sample, a fifth entry of information 11e in the form of a code that corresponds to the patient and sample used by the laboratory treating the sample, a sixth entry of information 11f that identifies the laboratory, and a seventh entry of information 11g that identifies the stain or other treatment applied to the sample by the laboratory. It should be understood that the label of FIG. 1 is simply illustrative of one example. Other kinds of information, information in different orders, formats or orientations, handwritten or typed, and more or less entries could be included on any one label. It is also possible for the slides or other mediums (such as paraffin blocks) to have one or more additional label, such as, for example, on the opposite end 3b of slide 3. The entries 11 may also be written on the slide or other medium without a label, on a tag attached to the medium, or provided by other means.

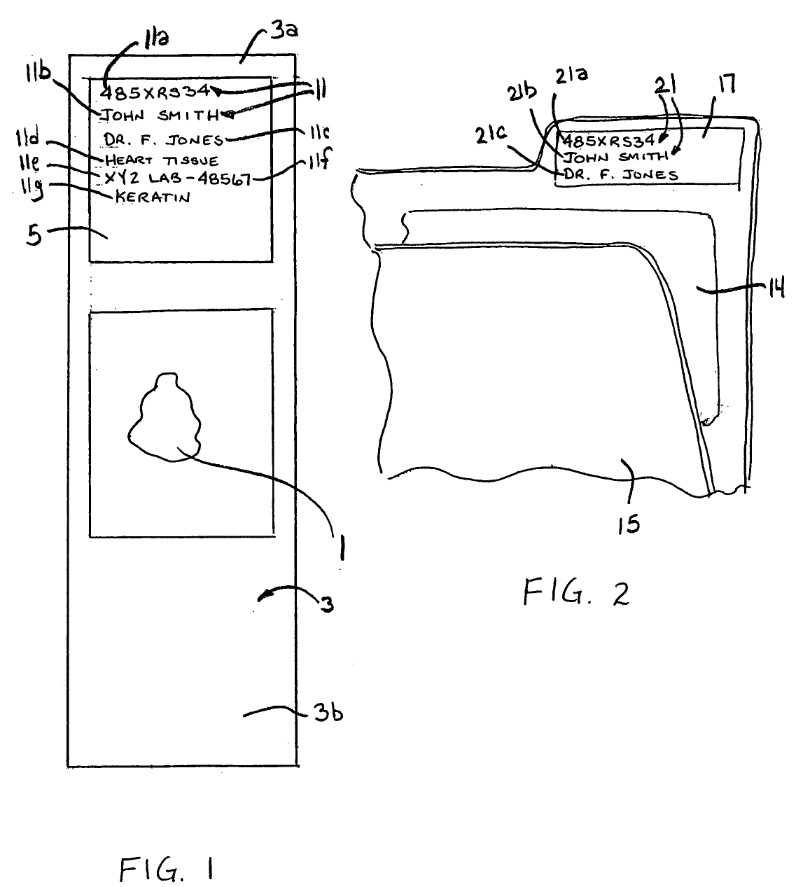

Sample 1 is often sent to the research facility along with other samples and/or medical records 14 retained in a folder 15 or the like (FIG. 2). These folders are also usually provided with a label 17 including various entries of information 21. As one example, label 17 includes a first entry of information 21a matching entry 11a, a second entry of information 21b providing the patient's name, and a third entry of information 21c identifying the treating physician. Of course, this and other information may be provided in different ways, with or without labels, together (as illustrated) or on different parts of the folder. As with the specimens, the folders and other information may include more or less information relevant to the research or study at hand. These records are provided to the researcher to provide him or her with a full complement of information of the patient's medical history. Various records or other materials within the folder or otherwise provided to the research facility (such as laboratory reports regarding the patient samples) may also have similar identifying information.

When the material is received by the research facility, it is preferably first routed to an individual who is not the researcher for this material, and is preferably not any one of the researchers for the facility, who for this application is referred to as the research administrator. Although the material could follow various routes within the research facility when received, it is forwarded to the administrator before being substantively considered by the researcher intending to conduct the study. The research administrator records the patient's name and/or other confidential patient identifying information (i.e., information by which the identity of patient can be known or determined) as well as the information relevant to the study, preferably, by entering the information in a computer. The administrator also preferably records all of the various materials and records sent by the treating physician to the research facility in order to provide a proper record of the materials received.

The administrator assigns the patient an arbitrary patient code 30, typically a series of numbers, letters and/or symbols, which is unique to this particular patient, i.e., no other patients providing samples to this research facility are provided with this code (or at least none other currently with this researcher). Moreover, the arbitrary code preferably has no connection to the name or other identifying information of the patient. Nevertheless, there could be some scheme that is used to produce the code so long as the researcher is not able to identify the name or other identifying information of the patient.

The administrator also preferably assigns each sample, folder or other received information with an identifying material code 31. The material code may be a sequence of numbers (e.g., 001, 002, etc.), an identifying series of letters, or an arbitrary code of numbers, letters and/or symbols. The material code may be joined with the patient code in a series of characters to form a single code, such as “123456789”, where the patient code portion is “123456” and the material code portion is “789”. Alternatively, they could be separated by a period, dash, etc.—for example, “123456-001 for patient “123456” and sample 001. Of course, the two codes could simply be written as two separate codes. Any code could be used so long as it permits the materials to be identified and the patient's identification hidden.

In the preferred process, the administrator enters all the information into a computer. The patient's name, address and/or other patient identifying information is entered into a first database that is accessible only by the administrator or at least only by those individuals who will not be conducting studies or assessing the research in regard to these particular samples. The patient code is matched with this information. The remaining information, such as the samples, treatments, relevant conditions, dates, etc., which is relevant to the study to be conducted is entered into a second database that is accessible by the researcher(s) as well as the administrator and any other person needing access. This second database identifies the patient only by way of the arbitrary patient code. The information can be stored and manipulated in a variety of different formats. For example, the information may be stored in a generally commercially available format such as in spreadsheet format. In this arrangement, the researcher may have access to only the columns with entries that do not identify the patient, whereas the administrator has access to all of the columns. Alternatively, the information may be stored in a specially developed software to facilitate the study of the particular research. Moreover, while a computer system is preferred, the process does not require the use of a computer. The information could be recorded and stored in a non-computer format so long as the patient identifying information is not accessible to those examining, studying or assessing information about the received samples and other information.

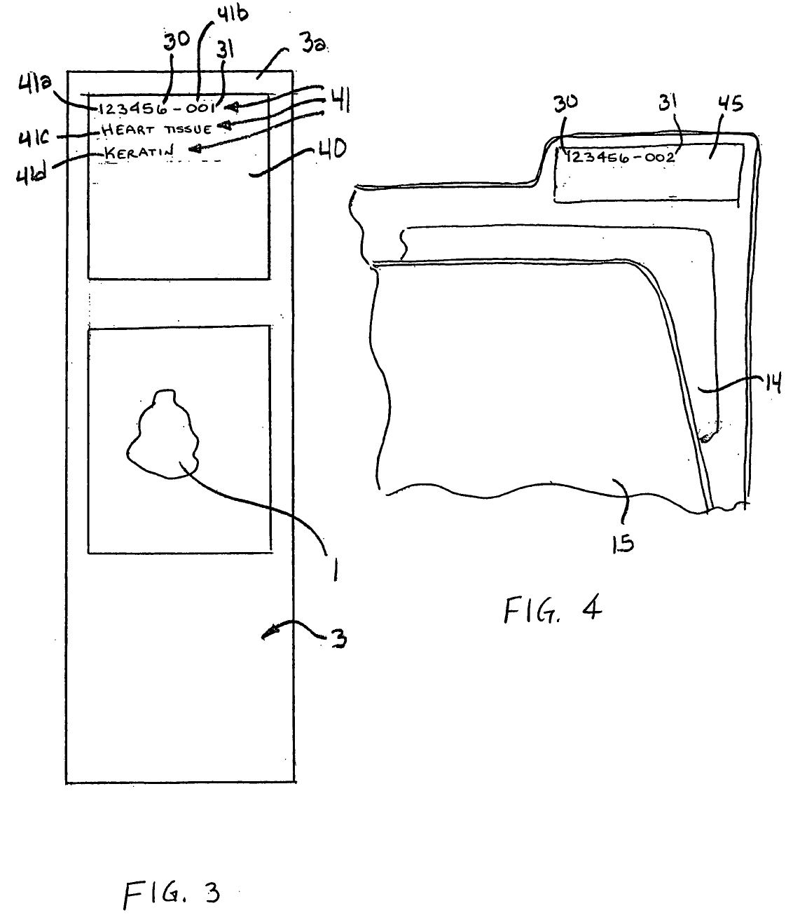

The research administrator or another person makes labels for the samples and other materials to be used or at least accessible by the researcher. The labels are generally the same size as generally used on the sample, folders or other records or materials received by the research facility, but could be other sizes. As one example, a label 40 is shaped to be of roughly the same size and configuration of label 5 (FIG. 3). Label 40 includes one or more entries of information 41. In one preferred embodiment, label 40 includes the arbitrary patient code as a first entry of information 41a, a number for the particular sample as a second entry of information 41b, an identification of the tissue as a third entry of information 41c, and the treatment applied to the sample as a fourth entry of information 41d. The information in 41b, c, and d, may be critical for the researcher to know in order to accurately analyze the specimen. In this embodiment, the label is simple and easy to read, though other arrangements and/or other information could be provided on the label.

Label 40 is affixed to slide 3 or other medium containing specimen 1 directly over label 5 or at least over the relevant entries of information 11 if there is no label 5. Label 40 is preferably superposed over label 5. Label 40 is opaque or otherwise fashioned with a dark color or design to prevent reading the material from label 5 to thereby ensure the patient's privacy. Label 40 is affixed with an adhesive that holds the label in place, but can be removed without damaging label 5 or the entries of information 11. In this way, label 40 can be safely removed when the study of the sample is completed and the sample returned to the treating physician. The label 40 will preferably have sufficient strength to hold together when it is removed, but it could have a weak construction, a tearing line or a tear away portion that can be used as an indication whether the label has been prematurely removed. The research facility will preferably require the researchers to verify that they have not removed labels 40, particularly when the labels are strong enough to be removed and replaced without detection.

Labels 45 are also made for the other records and materials sent with the samples (FIG. 4). Labels 45 are preferably of the same construction as labels 40, except that the size(s) is generally different. We these labels, each record, material and/or sample provided to the research facility that pertains to a particular patient is provided with a label that includes the arbitrary patient code 30 and/or other information. Each label also preferably also includes an identification or series number that can be used to identify each sample, record or material and ensure that nothing has been misplaced. Alternatively, each label could simply be provided with an arbitrary code that can be used in combination with a chart that identifies the materials pertaining to a particular code. Further, at least some labels could be blank to simply provide a cover each instance where the sample, record or other material includes patient identifying information. Also, labels could be provided in only those instances where patient identifying information is included.

As desired, the labels 40, 45 could be color coded to identify common projects, categories of diagnosis, etc. Further, the labels are preferably of standard sizes designated in commercially available word processing software and for standard laser jet printers for easy use.

The above discussion concerns the preferred embodiments of the present invention. Various other embodiments as well as many changes can be made without departing from the spirit and broader aspects of the invention as claimed.

1. A method for processing clinical materials for medical research comprising:
receiving from a source at least one item pertaining to a patient, the item including at least a first entry of information;
attaching a label with at least a second entry of information over the first entry of information on the item, the second entry of information lacking patient identifying information; and
studying the item after attaching the label.

2. The method of claim 1 in which at least one person receives and labels the item, and at least one other person studies the item.

3. The method of claim 2 wherein said other person studies the item only after the item has been labeled.

4. The method of claim 2 wherein the received item is a specimen from the patient on a medium.

5. The method of claim 4 wherein the label also includes an identification of treatment applied to the item.

6. The method of claim 5 wherein the label also includes an identification code for the item.

7. The method of claim 2 further including receiving a second item pertaining to the patient, and providing the second item with a second label having at least one entry of information that lacks patient identifying information.

8. The method of claim 7 in which each said label includes an arbitrary patient code that is unique to the patient.

9. The method of claim 8 wherein the first item is a specimen from the patient on a medium and the second item is a sheet with information pertaining to the patient.

10. The method of claim 2 wherein the item includes an initial label that has the first entry of information.

11. The method of claim 2 in which the label includes an arbitrary patient code that is unique to the patient.

12. The method of claim 2 further including recording patient identifying information related to the sample and matching the patient code to the recorded information, the recorded information being stored in a way that is accessible to said one person and inaccessible to said other person.

13. The method of claim 1 wherein the first entry of information includes patient identifying information.

14. The method of claim 13 wherein the second entry of information includes an arbitrary patient code that is unique to the patient.

15. The method of claim 1 wherein the label has an arbitrary patient code that is unique to the patient.

16. The method of claim 1 wherein the label is removed without destroying the first entry of information and the item returned to the source when the study is completed.

17. The method of claim 1 wherein the item is an electronic or digital copy and the label is an electronic label.

18. A method for processing clinical materials for medical research comprising:
receiving from a source at least one specimen pertaining to a patient, the specimen being supported on a medium including at least a first entry of information including patient identifying information;
attaching a label with at least a second entry of information over the first entry of information to prevent reading of the patient identifying information, the second entry of information including an arbitrary patient code and lacking patient identifying information;
recording the arbitrary patient code in connection with patient identifying information;
restricting access to the recorded patient identifying information to exclude at least one researcher; and
having said researcher study the specimen following attaching of the label.

19. The method of claim 18 wherein the recording of the arbitrary patient code is in a computer database where the researcher lacks access.

20. The method of claim 19 further including recording other information pertinent to studying the specimen in a second data base accessible by the researcher and matching said other information with the arbitrary patient code.

21. The method of claim 18 wherein the item is an electronic or digital copy and the label is an electronic label.
